(19) United States
(12) Patent Application Publication
(10) Pub. No.: US 2024/0427069 A1
(43) Pub. Date: Dec. 26, 2024

(54) Angular Shift Compensated Thin-Film Interference Optical Filters

(71) Applicant: EVERIX, INC., Orlando, FL (US)

(72) Inventors: Esmaeil Banaei, Orlando, FL (US); Justin Boga, Orlando, FL (US)

(21) Appl. No.: 18/828,817

(22) Filed: Sep. 9, 2024

Related U.S. Application Data
(63) Continuation-in-part of application No. 18/581,348, filed on Feb. 19, 2024.
Application No. 18/581,348 is a continuation of application No. 16/634,505, filed on Jan. 27, 2020, now Pat. No. 11,906,765.
(60) Provisional application No. 63/537,187, filed on Sep. 7, 2023.
(60) Provisional application No. 62/541,937, filed on Aug. 7, 2017.

(51) Int. Cl. G02B 5/28; G02B 1/115

(52) U.S. Cl. CPC G02B 5/285; G02B 1/115

(57) ABSTRACT

A filter assembly including a thin-film filter and a lens is disclosed with the effect of reducing angular shift experienced due to high angles of incidence from a light source. The thin-film filter is curved such that the filter surface is normal to the light rays emanating from a light source. Curvature of the thin-film filter is aided by the production of the multi-layer filter through a thermoforming process resulting in a flexible filter capable of being curved. The curved filter can be affixed to, or embedded within, a lens.

### CROSS REFERENCE TO RELATED APPLICATIONS

This application claims priority to U.S. Provisional Application No. 63/537,187 filed Sep. 7, 2023. This application is also a continuation-in-part of U.S. application Ser. No. 18/581,348 filed on Feb. 19, 2024, which is a continuation of U.S. application Ser. No. 16/634,505 filed on Jan. 27, 2020, which is a U.S. National Phase of PCT International Application No. 62/541,937 filed on Aug. 7, 2018, which in turn claims priority to U.S. Provisional Application No. 62/541,937 filed Aug. 7, 2017. The contents of each of these applications are incorporated herein by reference in their entirety.

### FIELD OF THE DISCLOSURE

This disclosure relates generally to methods of making thin-film interference optical filters.

### BACKGROUND

An optical filter is a device that selectively transmits light of different wavelengths, usually implemented as a glass plane or plastic device in the optical path, which are either dyed in the bulk or have interference coatings. The optical properties of filters are described by their frequency response, which specifies how the magnitude and phase of each light wave frequency component of an incoming signal is modified by the filter.

Filters mostly belong to one of two categories. The simplest, physically, is the absorptive filter. The other are interference or dichroic filters. Many optical filters are used for optical imaging and are manufactured to be transparent, while some are used for light sources and can be translucent.

Traditionally, such interference filters are made through vacuum deposition of transparent thin-film optical layers on a substrate of plastic or glass. The substrates, on which the thin-film layers are deposited, are typically in the thickness range 0.5 to 10 mm. Layer-by-layer coating and subsequent filter cutting induce tensions in the thin-film stack that often causes bending and cracking on the thin-film filter, especially if the substrate is too thin. This issue is more significant for filters with a large number of layers in order to achieve high optical performance. For obtaining a high optical density a large number of layers is required. Wide spectral ranges of blocking would require large numbers of layers. Sharp transition edges between high and low transmission level often require complex layer structures with a large number of layers with various refractive indices. Similarly, suppressing side reflection bands in order to create flat transmission curves often requires complex layer structures and large numbers of layers with various refractive indices.

Interference optical filters are known to demonstrate a shift of spectrum with increased angle of incidence. This angular shift causes challenges in many optical applications. For example, a notch interference optical filter that is designed to block a particular narrow range of wavelengths of light at normal incidence will no longer block that wavelength range at oblique angles that cause a sufficient shift in the spectrum, and instead blocks a neighboring range. Similarly, a bandpass interference optical filter that is designed to block a wide range of wavelengths and transmit a narrow range of wavelengths, will no longer transmit the target wavelengths range and instead block it if the angle of incidence is large enough to sufficiently shift the spectrum.

Known approaches to reduce the angular shift of a filter have focused on the introduction of high-index materials included in a coated multilayer of an optical filter. As will be appreciated by the instant disclosure, these known approaches have limitations and improved thin-film filters with a compensated angular shift are desired.

### SUMMARY OF THE DISCLOSURE

The following presents a simplified summary of the disclosure in order to provide a basic understanding of some aspects of the various embodiments disclosed herein. This summary is not an extensive overview of every detail of every embodiment. It is intended to neither identify key or critical elements of every embodiment nor delineate the scope of every disclosed embodiment. Its sole purpose is to present some concepts of disclosure in a simplified form as a prelude to the more detailed description that is presented later.

In one embodiment of the disclosure, a filter assembly can be provided between a light source emanating light rays and a destination. The filter assembly may include a thin-film filter having a plurality of individual thin-film layers and a lens. The filter may be curved in relation to the light source.

In another embodiment of the disclosure, a method of manufacturing a filter assembly may include a manufacturing a thin-film filter by a thermal drawing process, curving the thin-film filter, and combining the thin-film filter with a lens. The thin-film filter may include a plurality of individual, polymer layers.

The following description and annexed drawings set forth certain illustrative aspects of the disclosure. These aspects are indicative, however, of but a few of the various ways in which the principles disclosed may be employed. Other advantages and novel features disclosed herein will become apparent from the following description when considered in conjunction with the drawings.

### DETAILED DESCRIPTION OF THE DRAWINGS

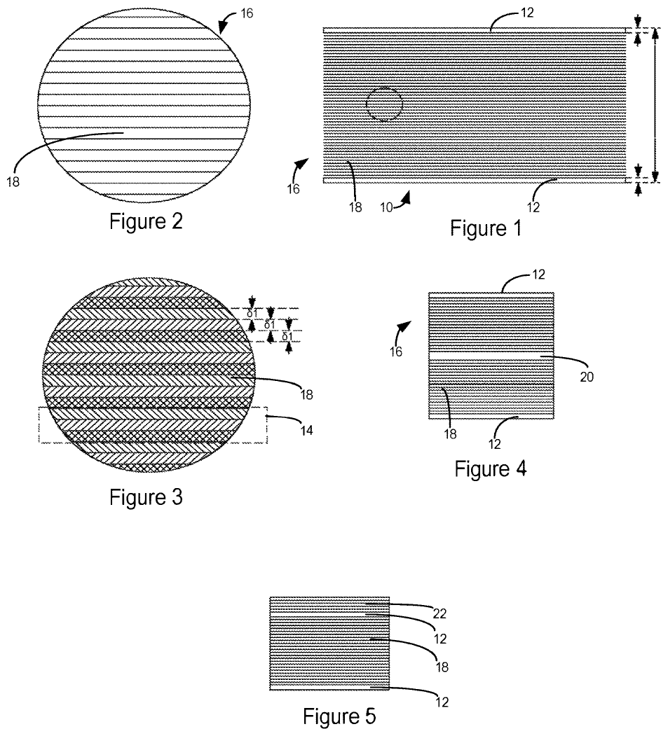

FIG. 1 shows a cross-section of a multilayer thin-film optical interference filter with two jacket layers;

FIG. 2 shows a partial detail of FIG. 1;

FIG. 3 shows a partial detail of a thin-film multi-layer stack composed of repeat unit blocks;

FIG. 4 shows a cross-section of a multilayer thin-film optical interference filter with two jacket layers and an intermediate layer disposed between two multilayer stacks;

FIG. 5 shows a cross-section of a multilayer thin-film optical interference filter with two jacket layers and antireflective layers on one of the jacket layers;

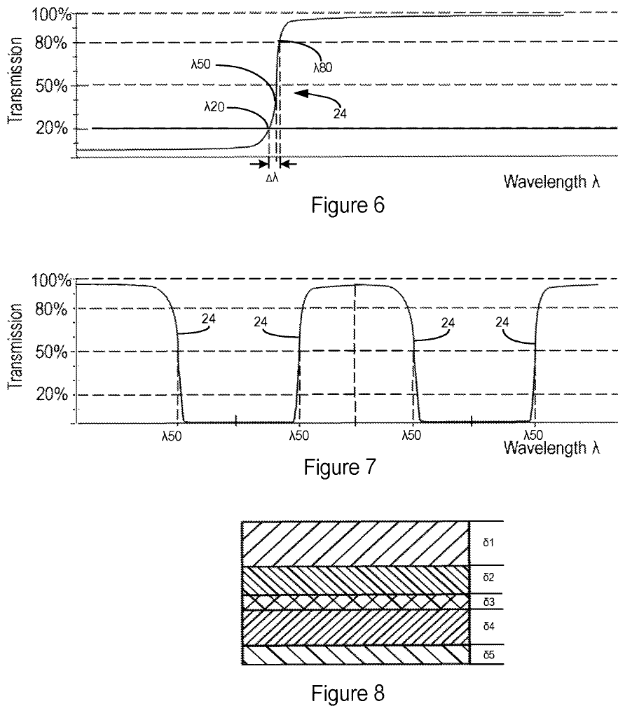

FIG. 6 shows a transmission spectrum with a transition edge from low transmission to high transmission;

FIG. 7 shows a transmission spectrum with four transition edges forming two blocking bands;

FIG. 8 shows a unit block of five different materials in five layers;

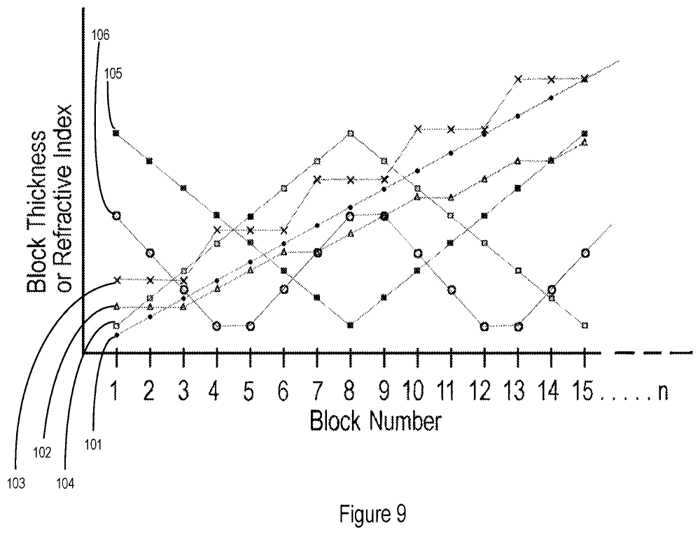

FIG. 9 shows various plots of unit block thicknesses, where the unit blocks are structured alike, but unit block thicknesses differ from one another by scaling factors;

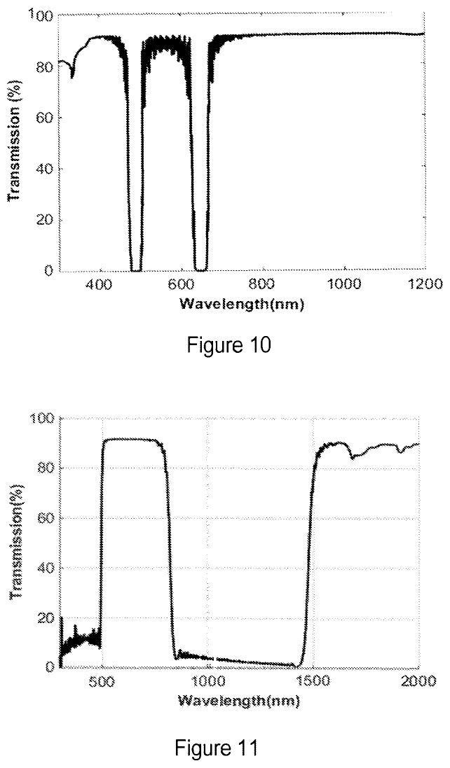

FIG. 10 shows a modeled transmission spectrum of a filter that includes two sets of quarter-wave layer stacks for different wavelengths without an interlayer (or with a transparent interlayer) between them;

FIG. 11 shows a modeled transmission spectrum of a filter that constitutes a bandpass filter;

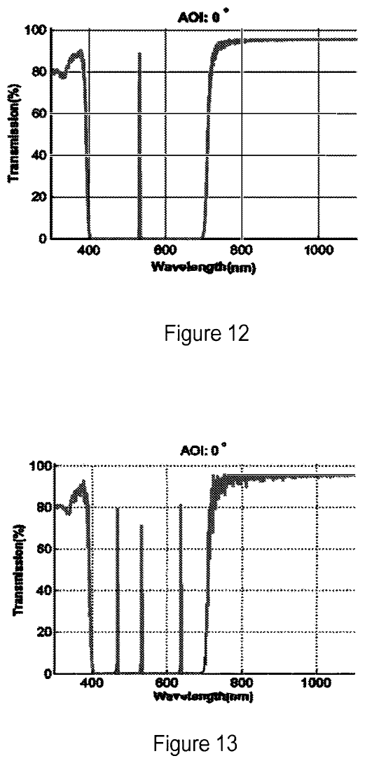

FIG. 12 shows a modeled transmission spectrum of a filter with a built-in defect layer;

FIG. 13 shows a modeled transmission spectrum of a filter with several built-in defect layers;

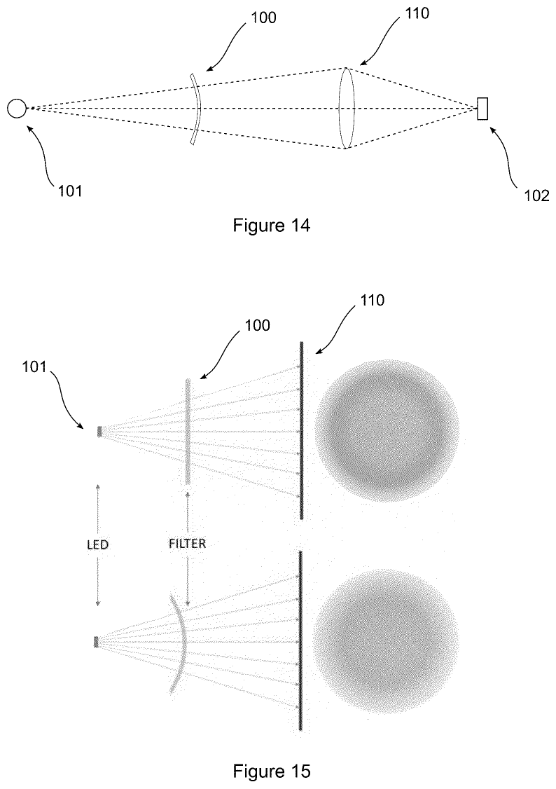

FIG. 14 shows filter assembly;

FIG. 15 shows a comparison between the angle-dependent wavelength shift for a curved filter versus a flat filter;

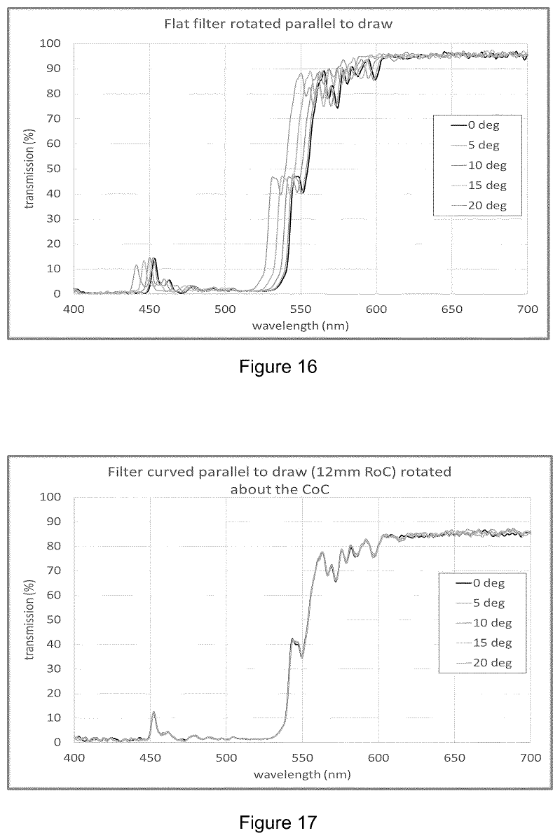

FIG. 16 shows a transmission spectrum demonstrating angular shift of a flat filter;

FIG. 17 shows a transmission spectrum demonstrating angular shift of a filter curved parallel to the direction of thermal drawing;

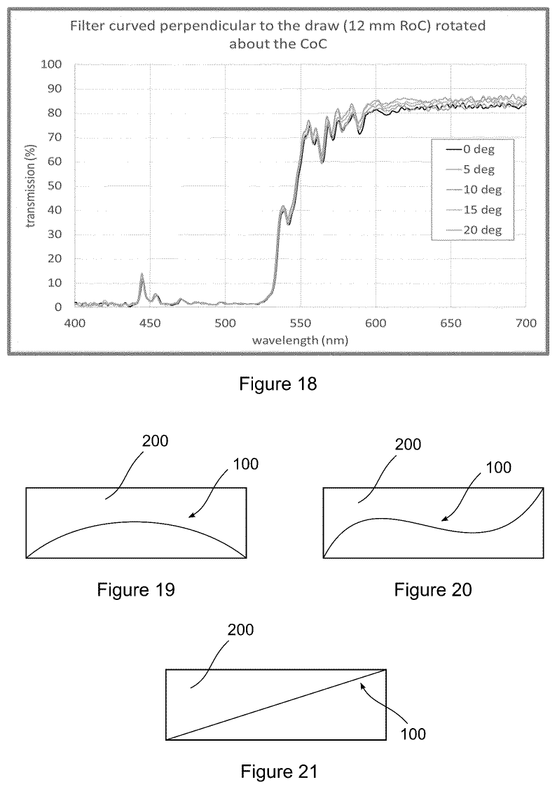

FIG. 18 shows a transmission spectrum demonstrating angular shift of a filter curved perpendicular to the direction of thermal drawing;

FIG. 19 shows a lens with an embedded, conically curved filter;

FIG. 20 shows a lens with an embedded, custom curved filter; and

FIG. 21 shows a lens with an embedded, flat and angled curved filter.

### DETAILED DESCRIPTION OF THE DISCLOSURE

The following detailed description and the appended drawings describe and illustrate some embodiments for the purpose of enabling one of ordinary skill in the relevant art to make use the invention. As such, the detailed description and illustration of these embodiments are purely illustrative in nature and are in no way intended to limit the scope of the invention, or its protection, in any manner. It should also be understood that the drawings are not necessarily to scale and in certain instances details may have been omitted, which are not necessary for an understanding of the disclosure, such as details of fabrication and assembly. In the accompanying drawings, like numerals represent like components.

FIGS. 1-13 generally show and describe exemplary embodiments of a thin-film optical interference filter. In a first example shown in FIG. 1, a multilayer thin-film optical interference filter 10 includes two jacket layers 12 and, sandwiched between the jacket layers 12, a multilayer stack 16 composed of dozens of thin-film layers 18 that are shown in a partial detail view in FIG. 2. The jacket layers may be transparent over the entire range of wavelengths of infrared (IR), visible, and ultraviolet (UV) light, or at least across all wavelengths transmitted by the multilayer stack 16 so that the jacket layers 12 to not substantially affect the optical properties of the thin-film filter. Substantially as used in the present application means within a range of 10%. Alternatively, one or both of the jacket layers 12 may constitute absorptive layers blocking one or more ranges of wavelengths that would otherwise be transmitted by the multilayer stack 16. In this application, unless indicated otherwise, the term blocking involves a transmission of less than 50% of the incident light energy, while absorbing more than 50% of the incident light energy. Each jacket layer 12, respectively, has a thickness in the range of 10-1000 times thicker than each individual thin-film layer 18 in the multi-layer stack 16.

In one general embodiment, the thin-film interference filter 10 includes a combination of thin-film interference multi layers 18 and absorptive or transparent interlayers 20 which are 10-1000 times thicker than individual thin-film layers in the multi-layer stacks 16, and this combination is surrounded from both sides with layers 12 of jacket materials each in the range 10-1000 times thicker than each individual thin-film layer in the multi-layer stack 16. The multilayer interference film of FIG. 4, for example, includes two multilayer stacks 16 bookended by two jacket layers. Between the two multilayer stacks 16, a further layer 20 is disposed that is thicker than the thickness of each individual thin-film layer 18 of the multilayer stacks 16. This thicker layer 20 may be an absorptive layer or a transparent layer.

The layers 18 in the multi-layer stacks 16 are in the thickness range of 5 nm to 5,000 nm, depending on the target wavelengths for filtering, the material's refractive index and optical performance of the filter that depends on layer structures and thickness distributions among layers to meet the conditions for destructive interference or constructive interference. The total thickness of the filter film 10 including the protective jacket layers 12 on both sides and, where present, any intermediate layers 20 is in the range 0.05 mm to 1 mm.

The filter film 10 is flexible such that it can be bent to a radius of curvature in the range 3 mm to 250 mm depending on the filter thickness and constituent materials, without permanently damaging, deforming or cracking the filter 10 as a whole, or its thin-film layers 18 in the multi-layer stacks 16.

The filter structure may also include up to 15 layers of anti-reflective thin films 22 on the outside of either jacket layers 12 responsible for reducing reflectivity as indicated in FIG. 5. A multilayer stack 16 is sandwiched between two jacket layers 12. On the outside of one jacket layer 12, several antireflective layers 22 are present to enhance the transmission of light. These anti-reflective layers 22 may be polymeric or glass-based, produced with the thermal drawing process, or coated on the filter films after filter subassemblies including all other layers 18, and optionally 12 or 22 are produced.

### General Optical Performance of the Filter Devices

The optical filters 10 described herein block parts of the spectral wavelength range between 300 nm and 25 microns for optical applications from UV across the visible light spectrum to the IR. Throughout this description, the terms “approximately” and “about” describe a deviation of up to ±15%, preferably ±5%.

The filters 10 have a transmission spectra with at least one transition edge between low and high transmission. For the purposes if this specific example, high transmission is defined as transmission more than 80% of the incident light. Low transmission is defined as transmission of at most 20% of the incident light. One example of a transition edge is shown in FIG. 6. FIG. 6 shows a transmission spectrum with a transition edge 24 from low transmission to high transmission with increasing wavelength λ. The edge slope of at least one such transition edge 24 between low and high transmission is in the range 0.02%-5%. This means that the difference Δλ between the wavelength λ80, at which the transmission reaches 80% closest to the high transmission range and the wavelength λ20 at which the transmission reaches 20% closest to the low transmission range is in the range 0.02%-5% of the wavelength λ50 at which the transmission equals 50% on the upward edge between the two points. The wavelength difference Δλ for the transition edge is, for example, less than 0 05% of the 50% transmission wavelength λ50 where a transmission band itself only has a width Δλ of 0.1 nm (e.g. as depicted in FIGS. 12 and 13), while the transition edge may extend over several percent of the 50% transmission wavelength λ50 for wider bands (as, for example shown in FIGS. 7, 10, and 11).

The transitional edge may be defined between different transmission levels than shown in this example, for example between 20% and 50% transmission, where the transmission in a bandpass, for example, does not reach a higher transmission level. In that case, the reference wavelength λ50 is the wavelength at which the transmission equals 50% of the highest transmission level of the transitional edge.

While the transmission level may fluctuate, up to 94% transmission can be achieved for high-transmission wavelengths without anti-reflective layers on the filter surfaces, with ambient air having a refractive index of approximately 1. With additional anti-reflective layers, the transmission for high-transmission wavelengths may reach up to 99% under the same ambient conditions.

The filter spectra may have up to 20 transition edges from high to low and from low to high transmission to provide multiple transmission and blocking ranges between adjacent transition edges. FIGS. 7 and 12, for example, show a total of four transition edges 24 with two blocking bands, and FIG. 13 shows a total of eight transition edges with four blocking bands, half of which are low-to-high transmission edges, and the other half of which are high-to-low transmission edges, respectively. The full width of a band at half maximum Λ50 (FWHM) of each transmission band or blocking band can be in the range 0.1% to 75% of the center wavelength of the same band. The lower limit of 0.1% corresponds to very narrow notch or bandpass filters as will be described below for Fabry Perot resonance cavities with spectra shown in FIGS. 12 and 13, while the upper level corresponds to wide notch or bandpass filters. Further details about layer structures that provide such transmission curves are below.

The transmission in low-transmission ranges can reach as low as 0.1%. 0.01%, 0.001%. 0.0001%, or even 0.00001% by using a sufficient number of interference layers 18 or by adding an absorptive layer 20 or 12 blocking a range of wavelengths.

### Various Layer Structures of the Filter Devices

As schematically indicated in FIG. 3, the thin-film multi-layer stack 16 in the filter film can be composed of unit blocks 14 that repeat multiple times in the stack 16. Each unit block can be made of up to 12 sublayers of up to 5 different materials. Internal sub-layers of each repeat unit block may be in the thickness range 1% to 75% of the total physical thickness of the repeat unit block 14. FIG. 3 shows unit blocks 14 with three layers 18 of identical thickness δ1 and different materials with different refractive indices, resulting in equal or different optical path lengths or optical thicknesses. Alternatively, FIG. 8 shows a unit block of five different materials in five layers that also differ in their thicknesses δ1, δ2, δ3, δ4, and δ5.

Optical thicknesses of the internal sub-layers may vary up to 90% lower or higher than the average optical thickness of all layers 18 in the unit block 14 due to either refractive index or thickness differences between sub-layers. Optical thickness is defined as the product of physical thickness, such as δ1, δ2, δ3, δ4, and δ5, and optical refractive index of the material which may vary with wavelength.

For example, the optical thickness of individual unit blocks 14 may be varied in such small increments such the optical thicknesses or refractive index as a function of thickness (position) across the multi-layer stack may be approximated to follow a sinusoidal or generally periodic curve. This creates a quasi-rugate structure without having to provide a continuously changing refractive index of a rugate structure throughout the thickness of the multilayer stack 16. In the simplest form, only three different refractive indices can form a periodic refractive index function that is similar to a saw-tooth function as a discreet approximate to a sinusoidal function.

A filter film 10 can have as few as 5 repeat unit blocks 14 or as many as 1000 unit blocks 14, not all of which need to be identical. Unit blocks 14 can be arranged in various ways in the multi-layer stack 16 of the thin-film filter 10. In one embodiment, in a simple case, they can all have the same total thicknesses. In other embodiments illustrated in plots 101 through 106 in FIG. 9, the unit blocks 14 in a filter stack 16 may be identical in material and order of layers 18, except for a scaling factor on their total thicknesses. This variation may be in a linear fashion as shown in plot 101 or in a non-linear fashion as shown in plots 102 and 103, increasing from one end of a multi-layer stack 16 to the other end. In another embodiment, the scaling factor may decrease from a highest value on one end of the stack 16 to a lowest value and increase back to a higher value as schematically indicated in plot 104, or vice versa as schematically indicated in plot 105. There may be multiple cycles of linear or non-linear fluctuations in the scaling factor of the unit block thicknesses across the multi-layer stack 16 as schematically indicated in plot 106.

Another embodiment may include a combination of at least two unit-block configurations of plots 101-106 (or other plots). The thicknesses of the unit blocks 14 as potted in FIG. 9 are not an exhaustive list of thickness variations, and the number of schematically depicted unit blocks is kept low for simplicity. Typical thin-film filters 10 will have tens to hundreds of unit blocks 14.

For example, FIG. 10 represents the transmission spectrum of a filter that includes two sets of quarter-wave layer stacks 16, each for a different wavelength. In the representative example, each quarter-wave layer stack 16 has 126 bi-layers, where each bi-layer is a unit block of two layers or several bi-layers can form a single unit block, corresponding to 252 layers per multilayer stack 16 composed of Poly Methyl Methacrylate (PMMA) and a second thermoplastic polymer whose refractive index is different from that of PMMA. The layers 18 in one stack 16 have a thickness of approximately 81 nm each, and the layers 18 in the second stack 16 have a thickness of approximately 108 nm each. This arrangement provides a transmission curve with two notches.

The filter 10 used for the transmission spectrum in FIG. 10 has a 0.025-mm thick intermediate layer 22 of PMMA between the two stacks 16 and one 0.025-mm thick layer of PMMA on either side of the device as protective jacket layers 12. The total thickness of this double notch filter 10 is approximately 0.122 mm. The transmission curve of this device provides a blocking in excess of 99.9% of two ranges of wavelength around 488 nm and 647 nm over a blocking bandwidth of about 30 nm to 40 nm and a transition slope smaller than 3% as defined above.

If the number of bi-layers in each stack 16 is reduced to 36, the resulting filter would still be able to block up to 99% of the same wavelength ranges. By co-drawing the filter layers, however, a multitude of bi-layers can be produced without requiring expensive coating processes.

FIG. 11 discloses a further example of a filter that constitutes a bandpass filter. The shown example is a transmission spectrum of a filter with a total of 580 bi-layers of the same polymeric materials as mentioned in the example above, with individual layer thicknesses varying in the range between 138 nm and 243 nm, and 0.025-mm-thick outside protective jacket layers. This filter has a total thickness of approximately 0.27 mm.

Selective bands of high and low transmission including the bands disclosed in the above, described examples, can be created by stacking much thicker sheets than the final layers 18 and optionally 12 and 22, but of the same relative thickness proportions as the final layers, in a pre-form that is subsequently drawn through a furnace, possibly repeatedly, to be stretched in the longitudinal direction until the layer thicknesses are reduced so far that they have reached the desired dimensions, while maintaining their thickness proportions.

In a further example, the periodicity of the unit blocks 14 with the scaling factor variations as mentioned above can be interrupted with at least one defect layer made of at least one of the constituent materials or a different material in such a way that the thickness of the at least one defect layer does not follow the periodic pattern of the unit blocks 14 of the rest of the multi-layer stack 16. This arrangement creates a Fabry Perot resonance cavity producing a very narrow band of high transmission.

FIG. 12 shows a representative example of a transmission spectrum of a filter 10 with a total of 1800 layers composed of unit blocks 14 with average layer thicknesses in each unit block 14 varying in the range 64 nm to 114 nm. A defect layer 22 that is 178 nm thick interrupts the periodicity of the layer thicknesses provides an optical transmission curve representing a narrow bandpass filter. The filter used of the example of FIG. 12 has protective jacket layers of 0.025 mm thickness on either side of the filter with a total filter thickness of approximately 0.21 mm.

FIG. 13 shows the transmission spectrum of a filter with three defect layers 22 of different thicknesses interrupting the layer periodicity three times. The filter used for FIG. 13 has similar protective jacket layers 12 of 0.025 mm thickness on both sides of the filter with a total filter thickness approximately 0.211 mm.

As an alternative to PMMA, Polycarbonate can be used as the major matrix polymer in conjunction with other thermoplastic polymers with different refractive indices than that of Polycarbonate. Chalcogenide glass materials containing various ratios of Arsenide, Sulfur, Selenide or Germanium demonstrate thermal and mechanical properties compatible with those of certain thermoplastics such as Polycarbonate, Polyetherimide and Polyethersulfone. Ultra-thin flexible filters can be made of alternating layers of at least one polymer and at least one such glassy material.

FIG. 14 shows an embodiment of a filter assembly for use between a light source 101 and a destination 102, such as an optical sensor or light detection device. The filter assembly may include a curved, thin-film filter 100 and a lens 110. Thin-film filter 100 may be a thermally formed thin-film filter such as the embodiments shown and described with respect to FIGS. 1-13. As should be appreciated from the disclosure, embodiments of thin-film filters will often have in excess of one hundred individual layers in order to achieve the desired optical properties. Some embodiments may exceed one thousand individual layers.

As shown in FIG. 15, one of the advantages of a curved thin-film filter as compared to a flat filter is that a curved filter prevents angle-dependent wavelength shift. When using a flat excitation filter in front of a light source, the flat filter interacts with the light from a number of angles of incidences simultaneously. Illumination through a flat filter thus results in a spectral bulls-eye pattern where the center of the illuminated field is illuminated by the longest wavelength and the edges are illuminated by the shortest wavelength.

Angular shift can be eliminated by forming curved filter 100 into a spherical dome, thus maintaining a zero-degree angle of incidence thereby eliminating the angular shift. A spherical dome is particularly effective where light source 101 is a point or focused source. For example, consider a commercial application of filter assembly incorporated into an aerial drone conducting a topographical survey. A focused light source, such as a laser, would be emanated from the drone located several hundred meters away from a terrain, and embodiments of the filter assembly could be employed to filter out ambient or noisy light to receive the laser emissions reflecting off the terrain. Because of the great distance between the terrain and the filter assembly incorporated into an aerial drone, employing a spherical or conical thin-film filter reduces the angular shift to zero or near zero.

In order to manufacture a curved thin-film filter, an embodiment of a multi-layer thin-film filter may be manufactured as a flat thin-film filter and then curved to a mold. Embodiments of thin-film filters disclosed herein are flexible and bendable whereas prior art thin-film filters are inflexible, brittle, and ill-suited or incapable to be curved as disclosed. This to-be-curved thin-film filter can be heated to a low temperature that is just above the glass transition temperature for the filter material but well below the melting temperature utilized in the thermoforming process. A low temperature heating of the filter can relax the filter material to avoid stress on the various layers of the formed filter. This low temperature heating process can benefit from non-uniform heating, such as multiple or disproportionately intense heat sources. Non-uniform or uneven heating can benefit the molding process because the outer edges of filter will experience greater sheer forces as they are bent further than the material at the center of the filter. Non-uniform heating can thus prevent over-heating of the filter material near the center of the filter that could damage or distort the filter's optical properties. Non-uniform heating can also prevent under-heating filter material near the distal edges of the filter that could result in local stress, cracking or damage to areas of the filter that were insufficiently heated. The low temperature heating process can also benefit from a long or extended heating period to give more time for the filter material to uniformly accommodate the stress of molding process.

While curving filter 100 into a spherical or conical shape can be advantageous, further embodiments of filter 100 may be custom curved to compliment the shape of the light source so as to reduce the angles of incidence from a light source emanating from multiple or irregular points in order to achieve a reduction in angular shift. A custom curvature can be achieved by utilizing a mold with a non-spherical shape, such as a complimentary shape to the light source.

FIGS. 16 through 18 demonstrate that the angular shift effect experienced by a flat filter is significantly reduced, if not eliminated, by a curved filter. FIG. 16 shows the changing spectrum as the angle of incidence of the light source is steadily increased from zero degrees to 20 degrees. By comparison, filters curved either parallel or perpendicular to the direction of thermal drawing during the filter's manufacture experienced significantly reduced angular shifting.

FIGS. 19 and 20 illustrate embodiments of a filtered lens where curved filter 100 is sandwiched between two optical elements 200 such as plano-convex or plano-concave lenses in the case of a zero-optical-power lens (i.e., a flat optical plate). FIG. 19 shows a side profile of a spherical or conical filter while FIG. 20 shows a custom-curved filter. Custom-curved filter shapes may be more ideal than conical curved shapes particularly if light rays from the light source are not normal to a curved lens surface or if the light waves have wavefronts more complex than simple diverging or converging patterns. Varying the curvature of the filter can manipulate the spectral shift effect without affecting the overall optical power effect of the lens 200 that the filter is embedded. Embodiments of this filtered lens with an embedded curved filter can be advantageous if the desired optical power for an optical element is non-zero.

Depending on the angle of incidence of the light source, angular shift reduction advantages can also be achieved by inserting a flat, but angled, filter 100 between two optical elements as shown in FIG. 21. The angular shift can be reduced by orienting the filter at an angle normal to the light source. In this case, the transmitted light ray will have a uniform color because the filter element has a uniform spectral response for all angles.

It should be appreciated that the filter assemblies disclosed herein are specifically directed to thin filters suitable for 3D sensors for consumer electronics, industrial, robotic, and automotive applications as a few examples.

The foregoing description of possible implementations consistent with the present disclosure does not represent a comprehensive list of all such implementations or all variations of the implementations described. The description of some implementations should not be construed as an intent to exclude other implementations described. For example, artisans will understand how to implement the disclosed embodiments in many other ways, using equivalents and alternatives that do not depart from the scope of the disclosure. Moreover, unless indicated to the contrary in the preceding description, no particular component described in the implementations is essential to the invention. It is thus intended that the embodiments disclosed in the specification be considered illustrative, with a true scope and spirit of invention being indicated by the following claims.

What is claimed:

1. A filter assembly to be provided between a light source and a destination, the filter assembly comprising:
a thin-film filter having a plurality of individual thin-film layers, the thin-film filter curved in relation to the light source; and
a lens.

2. The filter assembly of claim 1, wherein the thin-film filter is conical or spherical.

3. The filter assembly of claim 1, wherein the thin-film filter is positioned between the light source and the lens.

4. The filter assembly of claim 3, wherein the thin-film filter is affixed to a surface of the light source, the destination, or the lens.

5. The filter assembly of claim 1, wherein the thin-film filter is embedded within the lens.

6. The filter assembly of claim 5, wherein the lens comprises two optical elements, and the thin-film filter is sandwiched between the two optical elements.

7. The filter assembly of claim 1, wherein the lens comprises two optical elements

8. The filter assembly of claim 1, wherein the destination is an optical sensor.

9. The filter assembly of claim 1, wherein the thin-film filter has at least one hundred individual thin-film layers.

10. A method of manufacturing a filter assembly comprising:
manufacturing a thin-film filter by a thermal drawing process, the thin-film filter comprising a plurality of individual, polymer or glass layers;
curving the thin-film filter; and
combining the thin-film filter with a lens.

11. The method of claim 10 wherein the thin-film filter is curved into a conical or spherical shape.

12. The method of claim 10 wherein the thin-film filter is affixed to an outer surface of the lens.

13. The method of claim 10 wherein the thin-film filter is embedded in the lens.

14. The method of claim 10 wherein the thermal drawing process occurs at a first temperature and the curving process occurs at a second temperature lower than the first temperature but above a glass transition temperature for the polymer or glass layers.

15. The method of claim 14 wherein a non-uniform heat source is utilized during the curving process.

16. The method of claim 10 wherein the thin-film filter has at least one hundred individual, polymer or glass layers.
